(19) United States
(12) Patent Application Publication
(10) Pub. No.: US 2016/0286731 A1
(43) Pub. Date: Oct. 6, 2016

(54) Debris Blower

(71) Applicant: Michael Smith, Chattanooga, TN (US)

(72) Inventor: Michael Smith, Chattanooga, TN (US)

(21) Appl. No.: 14/675,686

(22) Filed: Mar. 31, 2015

(51) Int. Cl. A01G 1/12

(52) U.S. Cl. CPC A01G 1/125

(57) ABSTRACT

A debris blower that is operable to direct a first stream of air in a first direction and further direct a second stream of air in a second direction. The debris blower further includes a housing that is operable to secure a first blower motor and a second blower motor. The first blower motor has operably coupled thereto a first discharge tube wherein the first discharge tube directs a stream of air outward therefrom. The second blower motor has operably secured thereto a second discharge tube wherein the second discharge tube directs a stream of air in a direction independent of the first discharge tube. A pair of straps are secured to the housing to facilitate carrying of the debris blower.

### PRIORITY UNDER 35 U.S.C SECTION 119(E) & 37 C.F.R. SECTION 1.78

This nonprovisional application claims priority based upon the following prior U.S. Provisional Patent Application entitled: Leaf Blower, Application No. 61/973,682 filed Apr. 1, 2014, in the name of Michael Smith, which is hereby incorporated by reference for all purposes.

### FIELD OF THE INVENTION

The present invention relates generally to lawn care apparatus, more specifically but not by way of limitation a debris blower that is operable to blow leafs and other debris wherein debris blower includes a first discharge tube and a second discharge tube that can be independently operated so as to substantially double to area to be cleaned.

### BACKGROUND

Leaf blowers are well known in the art. A conventional leaf blower is typically used subsequent mowing of a lawn to remove grass clipping from a street or sidewalk. Convention leaf blowers are further used in yard care maintenance such as but not limited to corralling leaves to a particular area or removing debris from gutters and other areas around a house.

One problem with conventional leaf blowers is that the area in which they can cover is limited. Conventional leaf blowers typically include a blower motor that is either electric or a combustible motor wherein the motor is designed to discharge a rapid streak of air. The air discharge is typically directed outward from a discharge tube having a relatively small diameter nozzle. The average diameter of the nozzle is approximately 3 inches which provides a narrow discharge flow and thus a limited area that can be cleaned. The conventional diameter of the discharge tube and the fact that only one discharge tube is present requires a user to significantly traverse across the area in which they are attempting to clean.

Accordingly there is a need for a debris blower that substantially doubles the cleaning capacity of a conventional blower by providing a second discharge tube and a second blower motor.

### SUMMARY OF THE INVENTION

It is the object of the present invention to provide a debris blower that is operable to remove debris from a desired area using a stream of air wherein the debris blower includes a first discharge tube and a second discharge tube.

Another object of the present invention is to provide a debris blower that is operable to remove debris using a stream of air wherein it is contemplated within the scope of the present invention that the first discharge tube and second discharge tube are either coupled to one blower motor or have independent blower motors operably coupled thereto.

A further object of the present invention is to provide a debris blower operable to utilize a stream of air to clean an area wherein the first discharge tube and second discharge tube are operable to move independently of each other.

An additional object of the present invention is to provide a debris blower that is operable to utilize a stream of air generated from at least one blower motor and discharged from a first discharge tube and a second discharge tube that is designed to be portable.

Yet another object of the present invention is to provide a debris blower that includes a first discharge tube and a second discharge tube that are operable to direct two independent air streams that is lightweight and easy to use.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of a preferred embodiment of the present invention.

### DETAILED DESCRIPTION

Referring now to the drawings submitted herewith, wherein various elements depicted therein are not necessarily drawn to scale and wherein through the views and figures like elements are referenced with identical reference numerals, there is illustrated a debris blower 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

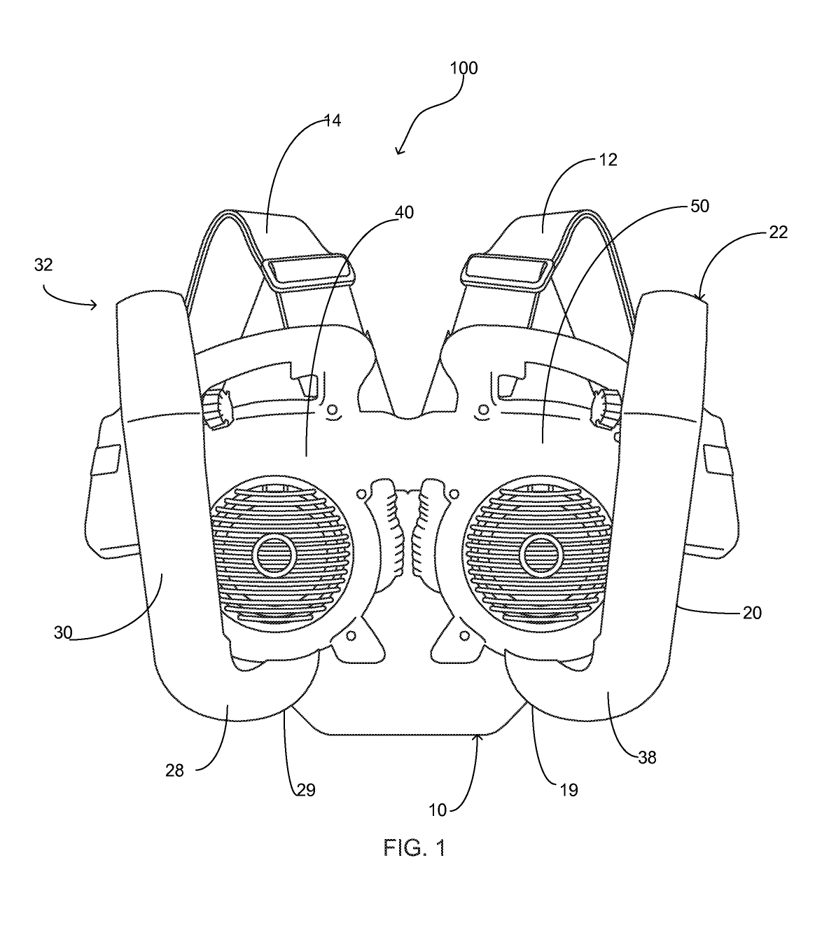

Referring in particular to FIG. 1 submitted herewith, the debris blower 100 includes a housing 10. The housing 10 is manufactured from a suitable durable material such as but not limited to metal or plastic. The housing 10 functions to provide a mounting means for the first motor 40 and second motor 50. Coupled to one side of the housing are first strap 14 and second strap 12. The first strap 14 and second strap 12 are conventional nylon adjustable straps and are operable to allow the debris blower 100 to be carried on a user's back similar to a backpack. While a first strap 14 and second strap 12 are illustrated and discussed herein, it is contemplated within the scope of the present invention that the debris blower 100 could utilize only one strap or include an alternative technique that would facilitate the carrying of the debris blower 100.

Secured to the housing 10 are a first blower motor 40 and a second blower motor 50. The first blower motor 40 and second blower motor 50 are conventional gas motors that are operable to produce a stream of air. While in the preferred embodiment the first blower motor 40 and second blower motor 50 are combustible gas blower motors, it is further contemplated within the scope of the present invention that first blower motor 40 and second blower motor 50 could be manufactured using conventional electric blower motors. The first blower motor 40 and second blower motor 50 are positioned on the housing 10 adjacent to each other in a side-by-side configuration. This is desirable as is promotes improved handling of the first discharge tube 30 and second discharge tube 20 on opposing sides of a person carrying the debris blower 100.

Operably coupled to the first blower motor 40 is first discharge tube 30. The first discharge tube 30 is tubular in shape having a hollow passage therethrough and further includes first end 29 and second end 30. The first discharge tube 30 is includes a flexible portion 28 proximate end 29. Flexible portion 28 facilitates the directional movement of the first discharge tube 30 with second end 32 operable to be directed in a desired position. The air stream produced by the first blower motor 40 is directed outwards therefrom and traverses through the first discharge tube 30 and exits an opening at end 32.

Operably coupled to the second blower motor 50 is second discharge tube 20. The second discharge tube 20 is tubular in shape having a hollow passage therethrough and further includes first end 19 and second end 22. The second discharge tube 20 is includes a flexible portion 38 proximate end 19. Flexible portion 38 facilitates the directional movement of the second discharge tube 20 with second end 32 operable to be directed in a desired position. The air stream produced by the second blower motor 50 is directed outwards therefrom and traverses through the second discharge tube 20 and exits an opening at end 22. The debris blower 100 utilizes the first discharge tube 30 and second discharge tube 20 to direct a first air stream and a second air stream in independent directions so as to facilitate a more efficient cleaning of a desired area.

While in the preferred embodiment discussed and illustrated herein, the debris blower 100 includes a first blower motor 40 and a second blower motor 50 operably coupled to first discharge tube 30 and second discharge tube 20 respectively, it is contemplated within the scope of the present invention that the debris blower 100 could be manufactured with one blower motor and utilize a y-shaped union to direct air produced from the one blower motor to direct air into the first discharge tube 30 and second discharge tube 20.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A debris blower comprising:
a housing;
at least one blower motor, said at least one blower motor being secured to said housing, said at least one blower motor operable to produce a stream of air;
a first discharge tube, said first discharge tube having a first end and a second end, said first end being operably coupled to said at least one blower motor;
a second discharge tube, said second discharge tube having a first end and a second end, said first end of said second discharge tube being operably coupled to said at least one blower motor; and
wherein said first discharge tube and said second discharge tube are operable to be movably independent so as to facilitate a first stream of air being directed in a first direction from said first discharge tube and a second stream of air being directed in a second direction from said second discharge tube.

2. The debris blower as recited in claim 1, wherein said first discharge tube includes a flexible portion, said flexible portion being proximate said first end of said first discharge tube.

3. The debris blower as recited in claim 2, wherein said second discharge tube includes a flexible portion, said flexible portion being proximate said first end of said second discharge tube.

4. The debris blower as recited in claim 3, and further including at least one strap, said at least one strap being secured to said housing, said at least one strap for transporting the debris blower.

5. The debris blower as recited in claim 4, wherein said at least one blower motor is a gas combustible motor.

6. The debris blower as recited in claim 4, wherein said at least one blower motor is an electric motor.

7. A debris blower operable to direct two streams of air in separate directions comprising:
a housing;
a first blower motor, said first blower motor being secured to said housing, said first blower motor operable to produce a stream of air;
a second blower motor, said second blower motor being secured to said housing, said second blower motor operable to produce a stream of air;
a first discharge tube, said first discharge tube having a first end and a second end, said first end being operably coupled to said first blower motor;
a second discharge tube, said second discharge tube having a first end and a second end, said first end of said second discharge tube being operably coupled to said second blower motor; and
wherein said first discharge tube and said second discharge tube are operable to be movably independent so as to facilitate a first stream of air being directed in a first direction from said first discharge tube and a second stream of air being directed in a second direction from said second discharge tube.

8. The debris blower as recited in claim 7, wherein said first discharge tube includes a flexible portion, said flexible portion being proximate said first end of said first discharge tube.

9. The debris blower as recited in claim 8, wherein said second discharge tube includes a flexible portion, said flexible portion being proximate said first end of said second discharge tube.

10. The debris blower as recited in claim 9, and further including a first strap and a second strap, said first strap and said second strap being secured to said housing, said first strap and said second strap operable to facilitate the carrying of the debris blower.

11. The debris blower as recited in claim 10, wherein said first blower motor is manufactured from one of the following types of motors: combustible or electric.

12. The debris blower as recited in claim 11, wherein said second blower motor is manufactured from one of the following types of motors: combustible or electric.

13. A debris blower operable to produce a first stream of air and a second stream of air wherein the first stream of air and second stream of air are directable in independent directions comprising:
a housing;
a first blower motor, said first blower motor being secured to said housing, said first blower motor operable to produce a stream of air;
a second blower motor, said second blower motor being secured to said housing, said second blower motor operable to produce a stream of air, wherein said first blower motor and said second blower motor are laterally adjacent to each other;
a first discharge tube, said first discharge tube being hollow having a passage therethrough, said first discharge tube having a first end and a second end, said first end being operably coupled to said first blower motor, said first discharge tube includes a flexible portion, said flexible portion being proximate said first end of said first discharge tube, said second discharge tube includes a flexible portion, said flexible portion being proximate said first end of said second discharge tube;
a second discharge tube, said second discharge tube being hollow having a passage therethrough, said second discharge tube having a first end and a second end, said first end of said second discharge tube being operably coupled to said second blower motor; and
wherein said first discharge tube and said second discharge tube are operable to be movably independent so as to facilitate a first stream of air being directed in a first direction from said first discharge tube and a second stream of air being directed in a second direction from said second discharge tube.

14. The debris blower as recited in claim 13, wherein said first blower motor is manufactured from one of the following types of motors: combustible or electric.

15. The debris blower as recited in claim 13, wherein said second blower motor is manufactured from one of the following types of motors: combustible or electric.

16. The debris blower as recited in claim 15, and further including a first strap and a second strap, said first strap and said second strap being secured to said housing, said first strap and said second strap operable to facilitate the carrying of the debris blower.
